(19) United States
(12) Patent Application Publication
(10) Pub. No.: US 2018/0035196 A1
(43) Pub. Date: Feb. 1, 2018

(54) New self-adaptive earcap

(71) Applicant: Fujikon Industrial Co., Ltd, Hong Kong (CN)

(72) Inventors: Siu Chung Yeung, Hong Kong (CN); Jian LIAO, Hong Kong (CN); Chao Sheng WANG, Hong Kong (CN)

(21) Appl. No.: 15/319,781

(22) PCT Filed: Jul. 4, 2016
(86) PCT No.: PCT/CN2016/000357

§ 371 Date: Dec. 18, 2016

(30) Foreign Application Priority Data
Nov. 30, 2015 (CN) 201510851281.6

(51) Int. Cl. H04R 1/10

(52) U.S. Cl. CPC H04R 1/1025; H04R 1/1058

(57) ABSTRACT

A new self-adaptive earcap belonging t the technical field of headsets is provided, including an earcap body, wherein the earcap body is made of soft silicone materials. A small boss is provided on a top surface of the earcap body, and a built-in chamber for receiving an in-ear earphone is provided inside the earcap body. A large circular opening for inserting in the in-ear earphone is provided on a bottom of the earcap body; and a small circular opening for inserting in the in-ear earphone is provided on a top of the earcap body. An elastic chamber is provided on a top of the built-in chamber, and the elastic chamber is provided below the small boss. The whole body of the earcap is made of soft silicone material by integral forming and has good elastic performance.

### CROSS REFERENCE OF RELATED APPLICATION

This is a U.S. National Stage under 35 U.S.C 371 of the International Application PCT/CN2016/000357, filed Jul. 4, 2016, which claims priority under 35 U.S.C. 119(a-d) to CN201510851281.6, filed Nov. 30, 2015.

### BACKGROUND OF THE PRESENT INVENTION

### Field of Invention

The present invention relates to the technical field of headsets, and more particularly to a new self-adaptive earcap.

### Description of Related Arts

According to external dimensions, most of the wireless headsets can be grouped into three types: in-ear earphone, headset and plug-in earphone, wherein the in-ear earphone has characteristics of light weight, small size and carrying convenience.

The conventional in-ear earphone comprises an earcap and a earphone body, wherein the earcap is sleeved on a pipe of the earphone body. The effect of the earcap is to insert in the earhole to make the earphone more steady wearing. The conventional in-ear earphone usually needs replacing earcap with different sizes according to different sizes of ear, which needs a user to try out the earcap while getting the earphone, so as to choose earcap which is more suitable for wearing. However, since the manufactures are only capable of providing about three kinds of earcaps, which may cause a result that the user is not capable of choosing a suitable earcap and finally choose an earcap which is not so suitable, which makes the suitable level of the earphone decreases, and even cause a result that the sound effect of the earphone changes and has an error with the actual effects, resulting in unpredictable consequences, affecting the headset sales and reputation.

Accordingly, the present invention develops a new earcap for meeting the demands of various customers.

### SUMMARY OF THE PRESENT INVENTION

An object of the present invention is to overcome the shortcoming mentioned above and providing a new self-adaptive earcap which has good air tightness, comfort and stability while wearing and is capable of shielding noises outside better.

The object of the present invention is implemented by the following solutions.

A new self-adaptive earcap comprises an earcap body, wherein the earcap body is made of soft silicone material. The soft silicone material has a good elasticity and is capable of closely fitting cavum conchae of the human body. A small boss is provided on a top surface of the earcap body. A surface shape of the small boss is identical to a shape of the cavum conchae, so as to be matched with the cavum conchae. The soft silicone material achieves a better integral fit and is very comfortable.

A built-in chamber for receiving an in-ear earphone is provided inside the earcap body, a shape of an internal wall of the built-in chamber is identical to an external surface of a middle portion of the in-ear earphone for matching therewith; a large circular opening for inserting in the in-ear earphone is provided on a bottom of the earcap body, a small circular opening for inserting in a pipe of the in-ear earphone is provided on a top of the earcap body; the small circular opening is provided on an end portion of the small boss, a center vertical line of the small circular opening forms an included angle with a center vertical line of the large circular opening. An effect of the included angle is to make the earcap more suitable for the ear of the human being, so as t improve the wearing comfort level. Both the large circular line and the small circular line is conducted with the built-in chamber, the in-ear earphone is inserted from the large circular opening upwardly to the built-in chamber, the pipe on a surface of the in-ear earphone passes through the small circular opening. While in use, a conventional earplug can be provided on the pipe of the in-ear earphone, and the earplug is for stuffing into an earhole. After installation, the earcap body is ensured to be covered in the middle portion of the in-ear earphone; an elastic chamber is provided on a top of the built-in chamber, the elastic chamber is provided below the small boss, and a bottom of the elastic chamber is contacted with a top surface of the in-ear earphone. Design of the elastic chamber makes the top portion of the earcap contacting with the ear of the human being soft and deformable.

Preferably, the elastic chamber comprises at least two elastic rib extending vertically and downwardly, a bottom of the elastic ribs extends to contact a surface of the in-ear earphone, and a gap is provided between two adjacent elastic ribs. The elastic chamber is implemented by elastic deformation of the elastic ribs, wherein a size of the elastic ribs can be regulated according to the structural requirements.

Preferably, an arc chamber is provided on an internal side of the built-in chamber. The arc chamber has elastic effect and is closely fitted with a tragus after elastic deformation. Design of the elastic chamber is to make the position of the earcap body contacting with the tragus soft and deformable. Cooperating with the small boss and the structure of the elastic chamber, the integral body of the earcap is steadier, not easy shed off and comfortable.

Preferably, an external surface of the earcap body is an arc fitting face for matching and clamping an internal surface of a tragus, wherein a position of the arc fitting face is corresponding to a position of the arc chamber.

Preferably, the included angle is at a range of 21-29 degrees.

Preferably, a horizontal distance between a center circle of the large circular opening and a center circle of the small circular opening is at a range of 8.0-8.6 mm.

Preferably, a vertical distance between the center circle of the large circular opening and the center circle of the small circular opening is at a range of 0.5-3.5 mm.

The values of the included angle, the horizontal distance and the vertical distance will affect the wearing comfort level. Combining with engineering principle of the human being, it is necessary to develop earcaps having various shapes and more suitable for different people. The values mentioned above are related to the cavum conchae, the tragus and the earhole, so as to ensure an optimal and comfortable wearing effect.

Preferably, clamping teeth are provided on an internal surface of the large circular opening for champing a surface of a bottom of the in-ear earphone. After the clamping teeth are designed, a bottom surface of the in-ear earphone requires a corresponding clamping slot, so as to achieve a perfect match.

Preferably, the earcap body is made of soft silicone material. The soft silicone material has good elasticity, wearing comfort and good fitting.

Beneficial effects of the present invention are as follows.

(1) The whole structure of the earcap body is formed by elastic material via integral forming, and an elastic chamber and an arc chamber are provided, wherein the elastic chamber is for closely fitting the cavum conchae, and the arc chamber is for fitting with a periphery of the tragus. The whole body has good elastic performance. In addition, a small boss for fitting the cavum conchae is further provided. The shape of the small boss is identical to the cavum conchae. After wearing, the combined action of the small boss, the elastic chamber and the arc chamber, the earcap is closely fitted with ear. The small boss, the elastic chamber and the arc chamber are all elastic structure and are capable of closely fitting with the ear. The earcap body is sleeved into the in-ear earphone for matching the earplug for use. While in use, the earplug is inserted to the earhole. Based on fixing the earplug on the in-ear earphone, a mall boss is additional added for fitting with the cavum conchae, so that the in-ear earphone is capable of fitting more closely with the cavum conchae and into the earhole, in such a manner that earcap wear is steady and not easy drop out, so as to decrease the trouble of dropping out the earcap in normal usage to a great extent.

(2) While wearing, the earplug is inserted into the ear hole, and the small boss is closely fitted on the cavum conchae. The earcap body is soft and elastic. The small boss has good elastic and is capable of fitting on the cavum conchae more comfortably. The whole body is very comfortable for wearing, the overall fit and tightness thereof is excellent. The earcap is capable of shielding noises outside, in such a manner that the music played by the in-ear earphone is more close to the original sound.

(3) The earcap body is made of silicone material with excellent elasticity, and the integral body is designed into a soft and flexible structure, so as to be adapted to different people for a suitable degree of tightness. In addition, the earplug can be replaced freely, so as to be suitable to most people, and more suitable for sports crowd.

(4) The earcap body is inserted into the in-ear earphone for utilizing combined with the earplug. Since a small boss, an elastic chamber and an arc chamber are provided in the earcap body, and the whole body thereof is formed by elastic material with excellent elasticity, the earcap deforms while wearing. The integral surface of the earcap body is closely fitting with the ear of the human body. In addition, the internal part of the earcap is closely fitted with the external surface after extruding, in such a manner that the contacting surface is increased and thus the friction is increased, so that connection between the earcap body and the in-ear earphone is steadier and not easy loosening.

These and other objectives, features, and advantages of the present invention will become apparent from the following detailed description, the accompanying drawings, and the appended claims.

### BRIEF DESCRIPTION OF THE DRAWINGS

FIG. 1 is a front view according to a preferred embodiment of the present invention.

FIG. 2 is a side view according to a preferred embodiment of the present invention.

FIG. 3 is a bottom view according to a preferred embodiment of the present invention.

FIG. 4 is a sectional view of the FIG. 3 taken along an A-A direction.

FIG. 5 is a structural exploded view showing a utilization state of a combination of a self-adaptive earcap and an in-ear earphone according to a preferred embodiment of the present invention.

FIG. 6 is a cross-sectional view showing a utilization state of the combination of the self-adaptive earcap and the in-ear earphone according to the preferred embodiment of the present invention.

FIG. 7 is a sketch view of a utilization state of the combination of the self-adaptive earcap and the in-ear earphone while being installed on an ear of a human body according to the preferred embodiment of the present invention.

FIG. 8 is a sectional view of a utilization state of the combination of the self-adaptive earcap and the in-ear earphone while being installed on an ear of a human body according to the preferred embodiment of the present invention.

Reference numbers in the Figs.: 1—earcap body; 2—earplug; 3—in-ear earphone; 4—large circular opening; 5—small circular opening; 6—small boss; 7—built-in chamber; 8 elastic chamber; 9—elastic rib; 10—human ear; 11—arc chamber.

### DETAILED DESCRIPTION OF THE PREFERRED EMBODIMENT

Further description of the present invention is illustrated according to a preferred embodiment of the present invention.

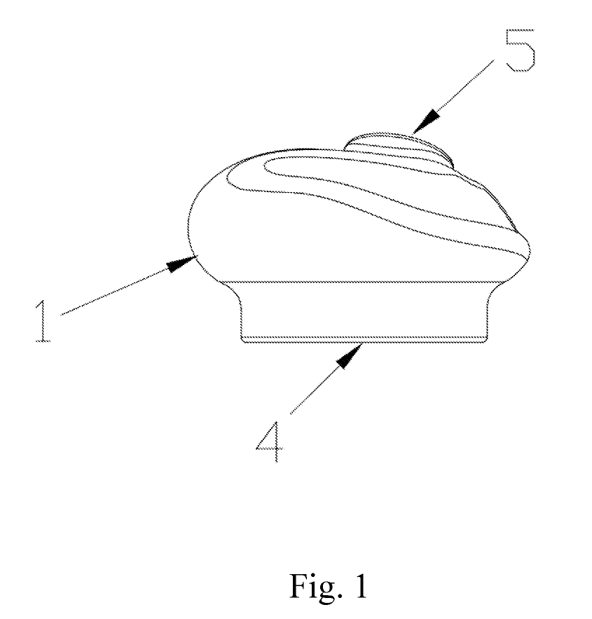

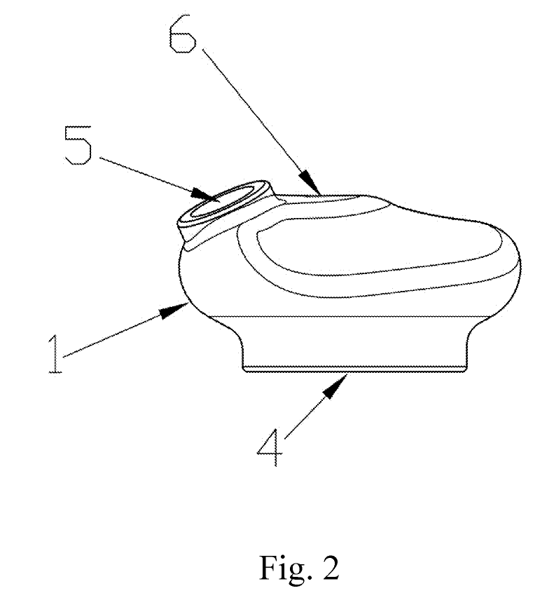

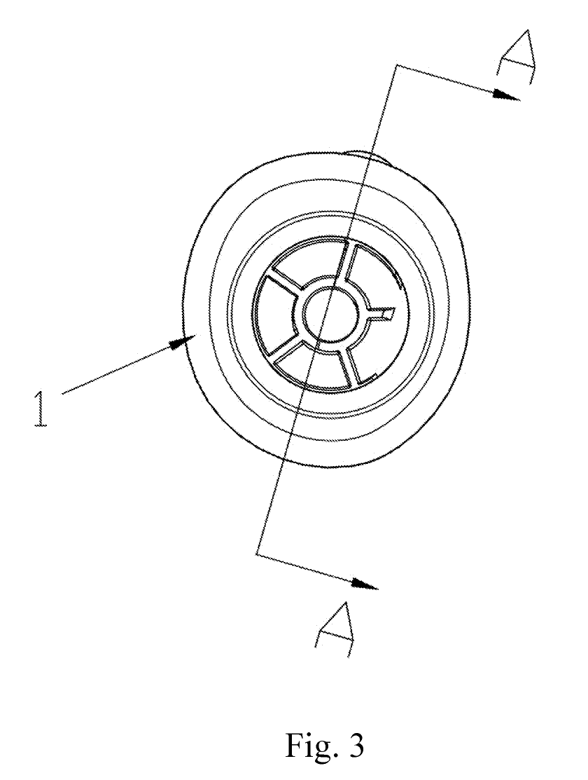

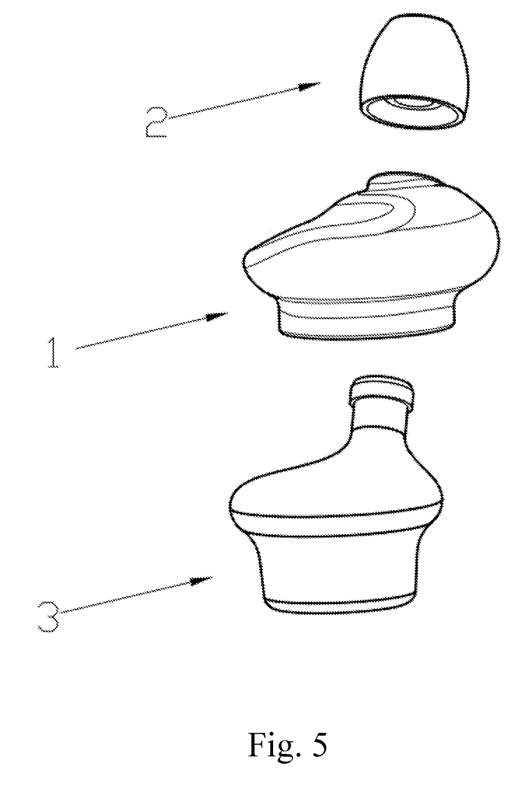

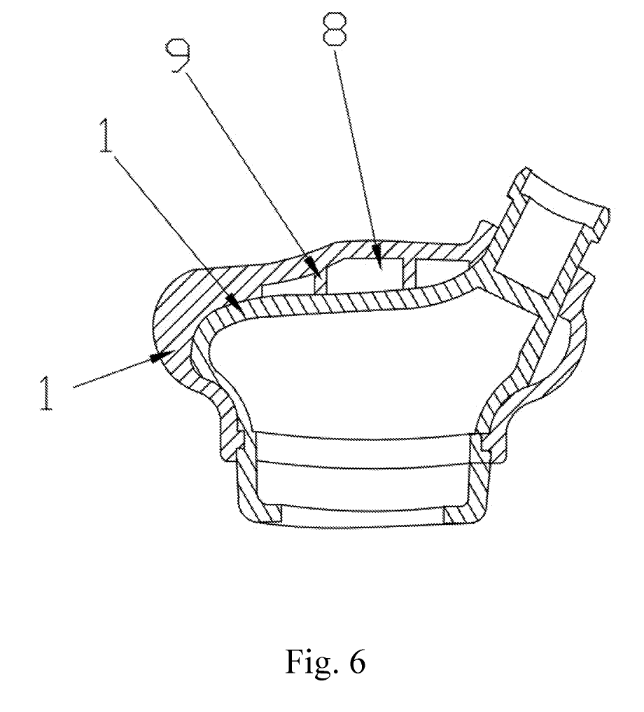

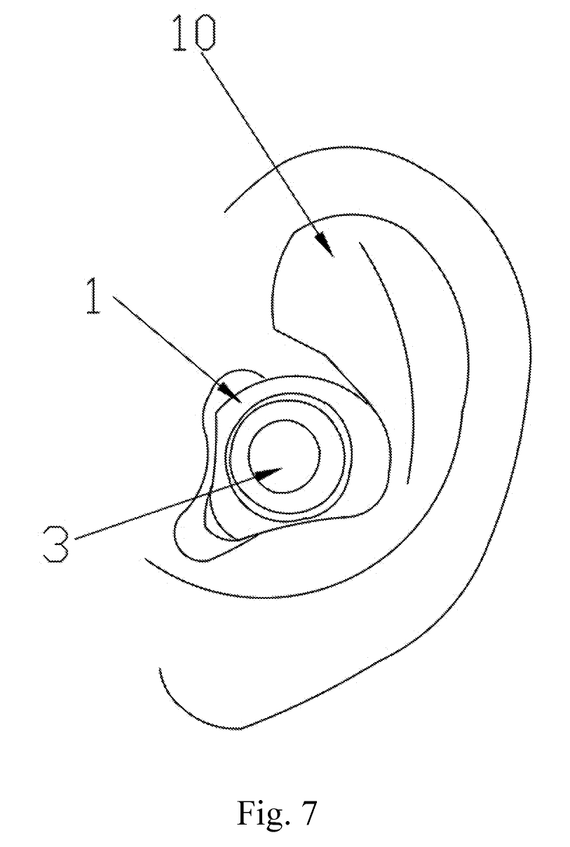

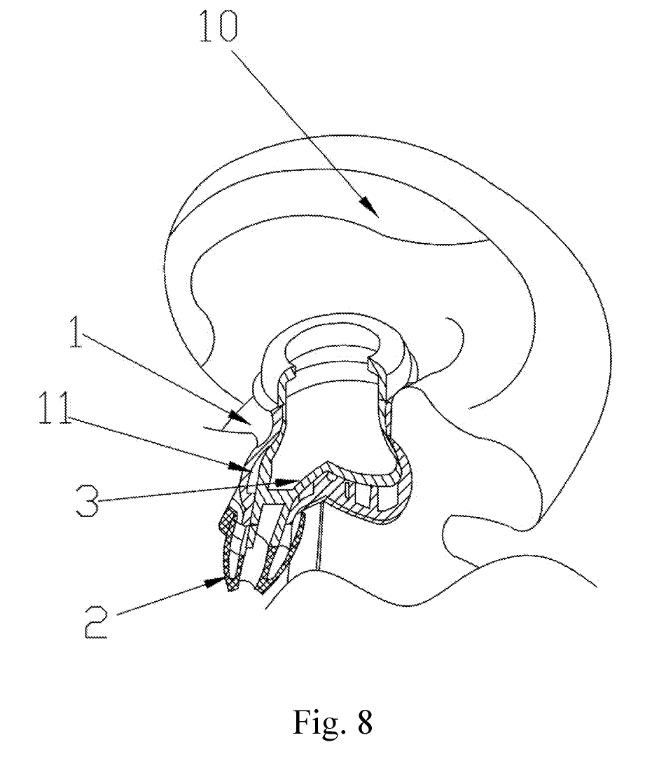

Referring to FIGS. 1-8, according to a preferred embodiment of the present invention, a new self-adaptive earcap comprises an earcap body 1, wherein the earcap body 1 is made of soft silicone material. As shown in FIG. 7 and FIG. 8, the soft silicone material has a good elasticity and is capable of closely fitting cavum conchae of the human body and providing a good feeling of comfort after being weared. In order to make the earcap fit in better on the cavum conchae. A small boss 6 is provided on a top surface of the earcap body. A surface shape of the small boss 6 is identical to a shape of the cavum conchae, so as to be matched with the cavum conchae. The soft silicone material achieves a better integral fit and is very comfortable.

A built-in chamber 7 for receiving an in-ear earphone 3 is provided inside the earcap body 1. A shape of an internal wall of the built-in chamber 7 is identical to a surface shape of a middle portion of the in-ear earphone. When installed, the earcap is covered on a surface of the middle portion of the in-ear earphone. A large circular opening 4 for inserting in the in-ear earphone 3 is provided on a bottom of the earcap body 1; and a small circular opening 5 for inserting in a pipe of the in-ear earphone 3 is provided on a top portion of the earcap. The small circular opening 5 is provided on an end portion of the small boss 6. A center vertical line of the small circular opening 5 forms an included angle with center vertical line of the large circular opening 4. According to the preferred embodiment, in order to accommodate most people, when the included angle is 25 degrees, the earcap has an optimal comfort level. In addition, when a horizontal distance between a center of the large circular opening 4 and a center of the small circular opening 5 is 8.3 mm, the earcap has an optimal comfort level; and when a vertical distance between the center of the large circular opening 4 and a center of the small circular opening 5 is 2 mm, the earcap has an optimal comfort level. An effective of the inductive angle is to make the earcap more suitable for the human ear, so as to improve the wear comfort.

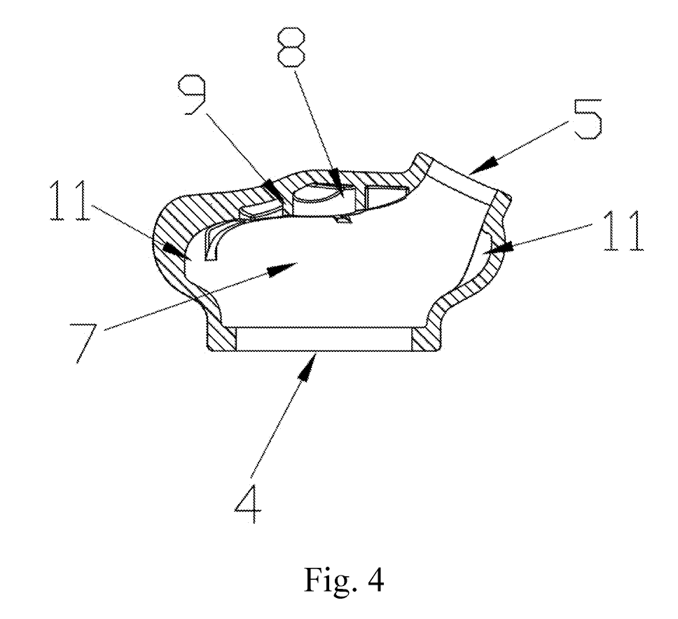

As shown in FIGS. 4, 5, 6 and 8, both the large circular opening 4 and the small circular opening 5 is conducted by the built-in chamber 7. The in-ear earphone 3 is inserted from the large circular opening 4 upwardly to the built-in chamber 7, and meanwhile, a pipe on a top portion of the in-ear earphone 3 passes through the small circular opening 5. While in use, a common earplug 2 can be directly installed on a pipe of the in-ear earphone 3, and the earplug 2 has an identical structure with the conventional earplug and is a detachable structure. The earplug 2 is for inserting in the earhole, and the earcap body 1 is ensured to be covered on a middle portion of the in-ear earphone. An elastic chamber 8 is provided on a top portion of the built-in chamber 7. The elastic chamber 8 is provided below the small boss 6. A bottom of the elastic chamber 8 is contacted with a top surface of the in-ear earphone 3. The design of the elastic chamber 8 makes the contact position between the top portion of the earcap and the human ear has excellent flexibility and is a shape-shifter. In the preferred embodiment, the elastic chamber 8 comprises at least two elastic ribs extending vertically and downwardly. A bottom of the elastic ribs extends to contact a surface of the in-ear earphone 3. A gap is provided between two adjacent elastic ribs 9, and the elastic chamber 8 is implemented by the deformation of the elastic ribs 9. A size of the elastic ribs 9 can be regulated according to the structural requirements. In addition, an arc chamber 11 is provided on an internal surface of the built-in chamber 7. An external surface of the earcap 1 is for matching and clamping an arc surface on an internal side of a tragus. The position of the arc surface is corresponding to a position of the arc chamber 11. The arc chamber 11 has an elastic effect as well and is closely adhered on the tragus after an elastic transformation.

As shown in FIGS. 7 and 8, the whole body of the earcap body 1 is formed by molding into an integral body of soft silicone material and has excellent elastic performance. In addition, the small boss 6 for fitting the cavum conchae is additionally provided. The small boss 6 has an identical shape with the cavum conchae. The earcap body 1 is sleeved on the in-ear earphone 3 and then is matched with the earplug 2 for utilization. While in use, the earplug 2 is inserted in an earhole. Based on that the earplug 2 fixes the in-ear earphone, a small boss 6 for fitting the cavum conchae is added, the in-ear earphone 3 is more closely to the cavum conchae and inserted to the earhole, so as to ensure a stable wear which is not easy to fall, in such a manner that the fall trouble of an earphone in normal use or activities is decreased to a maximum limit. While wearing, the earplug 2 is inserted into the earhole, and the small boss 6 is fitted on the cavum conchae. The earcap 1 is soft and elastic. The small boss 6 has good elasticity and can be suitably adhered on the cavum conchae. The integral body of the earcap of the present invention is very comfortable while wearing, the adhering and air impermeability thereof is excellent, the integral body of the earcap is capable of shielding noises better, in such a manner that music played by the in-ear earphone 3 is more closely to the original sound. The earcap body 1 is made of silicone material with excellent elasticity, and the integral body is designed into a soft and flexible structure, so as to be adapted to different people for a suitable degree of tightness. In addition, the earplug 2 can be replaced freely, so as to be suitable to most people, and more suitable for sports crowd.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

1-9. (canceled)

10. A self-adaptive earcap, comprising: an earcap body, wherein the earcap body is made of elastic material; a mall boss is provided on a top surface of the earcap surface, a shape of a surface of the small boss is identical to a cavum conchae for matching and fitting with the earcap; a built-in chamber for receiving an in-ear earphone is provided inside the earcap body, a shape of an internal wall of the built-in chamber is identical to an external surface of a middle portion of the in-ear earphone for matching therewith; a large circular opening for inserting in the in-ear earphone is provided on a bottom of the earcap body, a small circular opening for inserting in a pipe of the in-ear earphone is provided on a top of the earcap body; the small circular opening is provided on an end portion of the small boss, a center vertical line of the small circular opening forms an included angle with a center vertical line of the large circular opening, both the large circular line and the small circular line is conducted with the built-in chamber, the in-ear earphone is inserted from the large circular opening upwardly to the built-in chamber, the pipe on a surface of the in-ear earphone passes through the small circular opening, so as to ensure that the earcap body is covered in the middle portion of the in-ear earphone; an elastic chamber is provided on a top of the built-in chamber, the elastic chamber is provided below the small boss, and a bottom of the elastic chamber is contacted with a top surface of the in-ear earphone.

11. The new self-adaptive earcap, as recited in claim 10, wherein the elastic chamber comprises at least two elastic rib extending vertically and downwardly, a bottom of the elastic ribs extends to contact a surface of the in-ear earphone, and a gap is provided between two adjacent elastic ribs.

12. The new self-adaptive earcap, as recited in claim 10, wherein an arc chamber is provided on an internal side of the built-in chamber.

13. The new self-adaptive earcap, as recited in claim 11, wherein an arc chamber is provided on an internal side of the built-in chamber.

14. The new self-adaptive earcap, as recited in claim 10, wherein an external surface of the earcap body is an arc fitting face for matching and clamping an internal surface of a tragus, wherein a position of the arc fitting face is corresponding to a position of the arc chamber.

15. The new self-adaptive earcap, as recited in claim 13, wherein an external surface of the earcap body is an arc fitting face for matching and clamping an internal surface of a tragus, wherein a position of the arc fitting face is corresponding to a position of the arc chamber.

16. The new self-adaptive earcap, as recited in claim 10, wherein the included angle is at a range of 21-29 degrees.

17. The new self-adaptive earcap, as recited in claim 15, wherein the included angle is at a range of 21-29 degrees.

18. The new self-adaptive earcap, as recited in claim 10, wherein a horizontal distance between a center circle of the large circular opening and a center circle of the small circular opening is at a range of 8.0-8.6 mm.

19. The new self-adaptive earcap, as recited in claim 11, wherein a horizontal distance between a center circle of the large circular opening and a center circle of the small circular opening is at a range of 8.0-8.6 mm.

20. The new self-adaptive earcap, as recited in claim 15, wherein a horizontal distance between a center circle of the large circular opening and a center circle of the small circular opening is at a range of 8.0-8.6 mm.

21. The new self-adaptive earcap, as recited in claim 18, wherein a vertical distance between the center circle of the large circular opening and the center circle of the small circular opening is at a range of 0.5-3.5 mm.

22. The new self-adaptive earcap, as recited in claim 20, wherein a vertical distance between the center circle of the large circular opening and the center circle of the small circular opening is at a range of 0.5-3.5 mm.

23. The new self-adaptive earcap, as recited in claim 10, wherein clamping teeth is provided on an internal surface of the large circular opening for champing a surface of a bottom of the in-ear earphone.

24. The new self-adaptive earcap, as recited in claim 11, wherein clamping teeth is provided on an internal surface of the large circular opening for champing a surface of a bottom of the in-ear earphone.

25. The new self-adaptive earcap, as recited in claim 15, wherein clamping teeth is provided on an internal surface of the large circular opening for champing a surface of a bottom of the in-ear earphone.

26. The new self-adaptive earcap, as recited in claim 21, wherein clamping teeth is provided on an internal surface of the large circular opening for champing a surface of a bottom of the in-ear earphone.

27. The new self-adaptive earcap, as recited in claim 10, wherein the earcap body is made of soft silicone material.

28. The new self-adaptive earcap, as recited in claim 11, wherein the earcap body is made of soft silicone material.

29. The new self-adaptive earcap, as recited in claim 22, wherein the earcap body is made of soft silicone material.
